(19) United States
(12) Patent Application Publication
(10) Pub. No.: US 2015/0163706 A1
(43) Pub. Date: Jun. 11, 2015

(54) METHOD AND SYSTEM FOR PERFORMING CELL RESELECTION

(71) Applicant: He Wang, Shanghai (CN)

(72) Inventor: He Wang, Shanghai (CN)

(73) Assignee: ALCATEL LUCENT, Paris (FR)

(21) Appl. No.: 14/009,146

(22) PCT Filed: Mar. 28, 2012
(86) PCT No.: PCT/IB12/00879

§ 371 Date: Oct. 1, 2013

(30) Foreign Application Priority Data
Apr. 2, 2011 (CN) 201110084151.6

(51) Int. Cl. H04W 36/00

(52) U.S. Cl. CPC H04W 36/0061

(57) ABSTRACT

A method and an apparatus for performing cell reselection are provided. According to the embodiments, the method includes: selecting a first candidate reselection target cell set in which a cell reselection measurement result of each cell meets a first criterion; selecting a second candidate reselection target cell set from the first candidate reselection target cell set according to a cell reselection priority level of each cell in the first candidate reselection target cell set; and considering received Multicast Broadcast Single Frequency Network (MBSEN) region identification information of each cell in the second candidate reselection target cell set, and selecting a cell from the second candidate reselection target cell set to serve as a reselection target cell. Therefore, the continuity of receiving of a Multimedia Broadcast Multicast Service (MBMS) service can be improved as much as possible.

### BACKGROUND OF THE INVENTION

1. Field of the Invention

The present invention relates to the communications technologies, and more particularly, to a method and an apparatus for performing cell reselection.

2. Description of the Prior Art

It is well known that a user equipment (UE) can receive a Multimedia Broadcast Multicast Service (MBMS) service in both RRC_IDLE and RRC_CONNECTED states.

The UE may be moving, so that reselection from a source cell to a target cell may be needed.

According to relevant standards in the prior art, the problem of continuity of receiving of the MBMS service is not required to be taken into account during selection of a target cell.

Therefore, a target cell, which disrupts the continuity of receiving of the MBMS service, may be selected.

An objective of the present invention is to provide a solution, so as to improve as much as possible the continuity of receiving of the MBMS service when an RRC_IDLE UE performs cell reselection.

### SUMMARY OF THE INVENTION

According to a first aspect of the present invention, a method for performing cell reselection is provided, which includes:

selecting a first candidate reselection target cell set in which a cell reselection measurement result of each cell meets a first criterion;

selecting a second candidate reselection target cell set from the first candidate reselection target cell set according to a cell reselection priority level of each cell in the first candidate reselection target cell set; and

considering received Multicast Broadcast Single Frequency Network (MBSFN) region identification information of each cell in the second candidate reselection target cell set, and selecting a cell from the second candidate reselection target cell set to serve as a reselection target cell.

According to a second aspect of the present invention, a method for performing cell reselection is provided, which includes:

selecting a first candidate reselection target cell set in which a cell reselection measurement result of each cell meets a first criterion;

selecting a second candidate reselection target cell set from the first candidate reselection target cell set according to a cell reselection priority level of each cell in the first candidate reselection target cell set;

calculating a sorting value of each cell in the second candidate reselection target cell set; and

when the second candidate reselection target cell set has at least two cells each having the sorting value being greater than a threshold value, considering received MBSFN region identification information of the at least two cells, and selecting a cell from the at least two cells to serve as a reselection target cell.

According to a third aspect of the present invention, an apparatus for performing cell reselection is provided, which includes:

a first selection device, configured to select a first candidate reselection target cell set in which a cell reselection measurement result of each cell meets a first criterion;

a second selection device, configured to select a second candidate reselection target cell set from the first candidate reselection target cell set according to a cell reselection priority level of each cell in the first candidate reselection target cell set; and

a third selection device, configured to consider received MBSFN region identification information of each cell in the second candidate reselection target cell set, and select a cell from the second candidate reselection target cell set to serve as a reselection target cell.

According to a fourth aspect of the present invention, an apparatus for performing cell reselection is provided, which includes:

a first selection device, configured to select a first candidate reselection target cell set in which a cell reselection measurement result of each cell meets a first criterion;

a second selection device, configured to select a second candidate reselection target cell set from the first candidate reselection target cell set according to a cell reselection priority level of each cell in the first candidate reselection target cell set;

a calculation device, configured to calculate a sorting value of each cell in the second candidate reselection target cell set; and

a third selection device, configured to consider received MBSFN region identification information of at least two cells when the second candidate reselection target cell set has the at least two cells each having the sorting value being greater than a threshold value, and select a cell from the at least two cells to serve as a reselection target cell.

According to a fifth aspect of the present invention, a method for assisting in performing cell reselection is provided, which includes:

sending MBSFN region identification information of a neighboring cell.

According to a six aspect of the present invention, an apparatus for assisting in performing cell reselection is provided, which includes:

a sending device, configured to send MBSFN region identification information of a neighboring cell.

According to the present invention, the continuity of receiving of an MBMS service when an RRC_IDLE UE performs cell reselection can be improved as much as possible.

### BRIEF DESCRIPTION OF THE DRAWINGS

Other objectives and effects of the present invention will become clearer and easier to understand through the following description with reference to the accompanying drawings as the present invention is understood more and more comprehensively, in which:

FIG. 1 is a schematic view of an environment in which the present invention may be implemented;

FIG. 2 is a schematic flow chart of a method for performing cell reselection according to an embodiment of the present invention;

FIG. 3 is a schematic block diagram of an apparatus for performing cell reselection according to an embodiment of the present invention;

FIG. 4 is a schematic flow chart of a method for performing cell reselection according to an embodiment of the present invention; and

FIG. 5 is a schematic block diagram of an apparatus for performing cell reselection according to an embodiment of the present invention.

In all of the accompanying drawings, the same reference numerals indicate the same, similar or corresponding features or functions.

### DETAILED DESCRIPTION

Embodiments of the present invention are described below in detail with reference to the accompanying drawings.

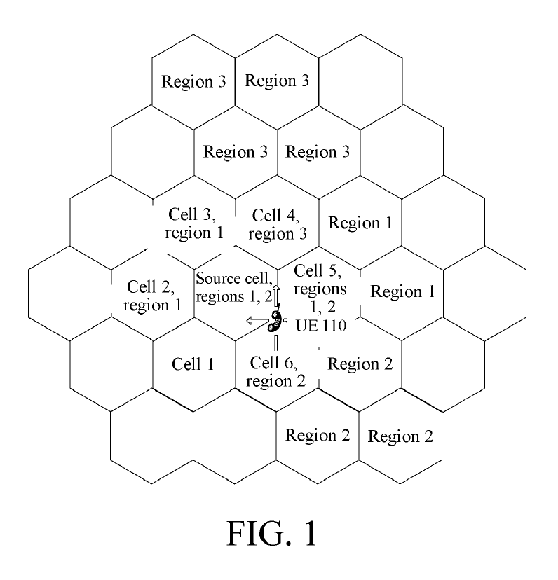

FIG. 1 is a schematic view of an environment in which the present invention may be implemented.

As shown in FIG. 1, an environment 100 includes multiple cells. Cells marked with region 1 belong to an MBSFN region 1, cells marked with region 2 belong to an MBSFN region 2, cells marked with region 3 belongs to an MBSFN region 3, and other cells do not belong to any MBSFN region.

It can be seen from FIG. 1 that a source cell, in which a UE 110 resides, belongs to the MBSFN region 1 and the MBSFN region 2, and among 6 neighboring cells of the source cell, a neighboring cell 1 does not belong to any MBSFN region, a neighboring cell 2 belongs to the MBSFN region 1, a neighboring cell 3 belongs to the MBSFN region 1, a neighboring cell 4 belongs to the MBSFN region 3, a neighboring cell 5 belongs to the MBSFN region 1 and the MBSFN region 2, and a neighboring cell 6 belongs to the MBSFN region 2. Furthermore, without loss of generality, it is assumed that the MBSFN region 1 operates on a frequency 1, the MBSFN region 2 also operates on the frequency 1, and the MBSFN region 3 operates on a frequency 2.

Furthermore, as shown in FIG. 1, the UE 110 is located on an edge of the source cell thereof, and if the UE 110 continues to move, a cell reselection process may occur.

Furthermore, without loss of generality, in the following description, it is assumed that the UE 110 is in an RRC_IDLE state, so that the UE 110 executes the cell reselection process described below, and a corresponding apparatus is a UE.

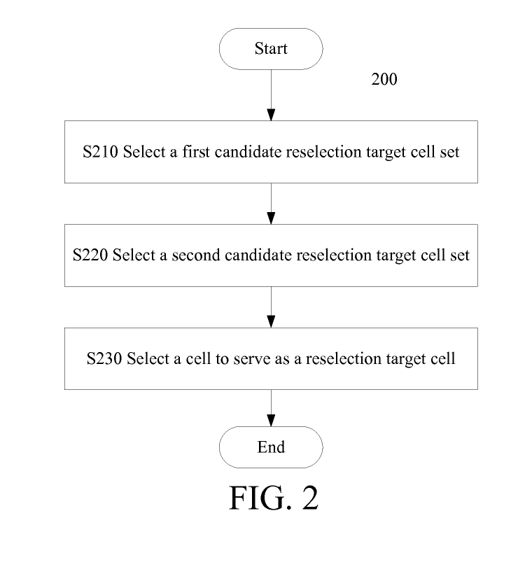

FIG. 2 is a schematic flow chart of a method for performing cell reselection according to an embodiment of the present invention.

As shown in FIG. 2, a method 200 includes the following steps. In Step S210, a first candidate reselection target cell set in which a cell reselection measurement result of each cell meets a first criterion is selected. In Step S220, a second candidate reselection target cell set is selected from the first candidate reselection target cell set according to a cell reselection priority level of each cell in the first candidate reselection target cell set. In Step S230, received MBSFN region identification information of each cell in the second candidate reselection target cell set is considered, and a cell is selected from the second candidate reselection target cell set to serve as a reselection target cell.

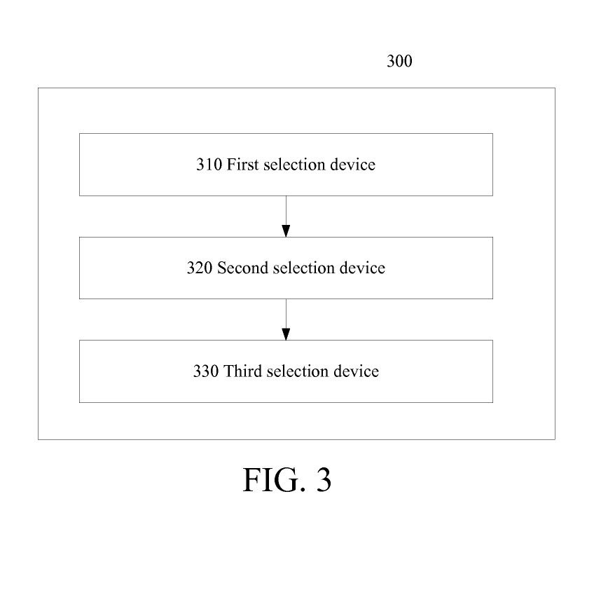

Correspondingly, FIG. 3 is a schematic block diagram of an apparatus for performing cell reselection according to an embodiment of the present invention.

As shown in FIG. 3, an apparatus 300 includes a first selection device 310, configured to select the first candidate reselection target cell set in which the cell reselection measurement result of each cell meets the first criterion; a second selection device 320, configured to select the second candidate reselection target cell set from the first candidate reselection target cell set according to the cell reselection priority level of each cell in the first candidate reselection target cell set; and a third selection device 330, configured to consider the received MBSFN region identification information of each cell in the second candidate reselection target cell set, and select a cell from the second candidate reselection target cell set to serve as a reselection target cell.

The first criterion is, for example, an S criterion. The meaning of the S criterion is that only if a measurement result of a neighboring cell meets a certain condition, can the neighboring cell be a member of the first candidate reselection target cell set. The frequency of a member cell in the first candidate reselection target cell set and the frequency of the reselection source cell may be the same or different. For details of the S criterion, the standard 3GPP TS36.304 V9.1.0 may serve as a reference. The first candidate reselection target cell set meeting the S criterion includes a candidate reselection target cell having the same frequency as the reselection source cell, and also includes a candidate reselection target cell having the frequency different from that of the reselection source cell. Furthermore, candidate reselection target cells in the first candidate reselection target cell set may have different cell reselection priority levels.

Furthermore, the cell reselection priority level is determined based on the frequency.

For example, the standard 3GPP TS36.304 V9.1.0 describes a cell reselection process of a UE in the RRC_IDLE state. An important rule of the cell reselection process is that the cell reselection is performed based on the cell reselection priority level of a neighboring cell. Currently, the cell reselection priority level is based on a frequency layer rather than based on the cell. That is to say, in a radio access technology (RAT), all cells having the same frequency have the same cell reselection priority level, and cells having different frequencies may have the same cell reselection priority level or different cell reselection priority levels. That is to say, if the cell reselection priority level of a cell is different from the cell reselection priority level of another cell, the frequencies of the two cells are definitely different. However, if the cell reselection priority level of a cell is the same as the cell reselection priority level of another cell, the frequencies of the two cells may be the same or different.

Absolute priority levels of different frequencies may be provided to the UE through, for example, an information unit “cellReselectionPriority” through a system information block. The information unit “cellReselectionPriority” is transmitted in system information blocks SIB-3 and SIB 5-8 defined in the standard 3GPP TS36.331 V9.1.0. When the UE switches from an RRC_CONNECTED state to the RRC_IDLE state, an RRCConnectionRelease message may be used to inform the UE of the cell reselection priority level. When the UE receives “cellReselectionPriority” from the RRCConnectionRelease message, the UE ignores “cellReselectionPriority” in the system information block.

In Step S220 and the device 320, the second candidate reselection target cell set having the same highest cell reselection priority level is selected from the first candidate reselection target cell set.

Furthermore, for neighboring cells having the same frequency, if the neighboring cells belong to at least one MBSFN region, the source cell of the UE may inform the UE of MBSFN region identification information of the neighboring cells through the SIB-4. An SIB-4 information unit including the MBSFN region identification information is provided below:

-- ASN1START
SystemInformationBlockType4 : := SEQUENCE {

| | | |
|---|---|---|
| intraFreqNeighCellList | IntraFreqNeighCellList | OPTIONAL, -- Need OR |
| intraFreqBlackCellList | IntraFreqBlackCellList | OPTIONAL, -- Need OR |
| csg-PhysCellIdRange | PhysCellIdRange | OPTIONAL, -- Cond CSG |

. . .
}
IntraFreqNeighCellList : := SEQUENCE (SIZE (1. .maxCellIntra)) OF IntraFreqNeighCellInfo
IntraFreqNeighCellInfo : := SEQUENCE {

| | |
|---|---|
| PhysCellId | PhysCellId, |
| q-OffsetCell | Q-OffsetRange, |
| mbsfn-AreaIdList | SEQUENCE (SIZE(1. .maxMBSFN-Area)) OF |
| | INTEGER (0. .255) OPTIONAL, |

. . .
}
IntraFreqBlackCellList : := SEQUENCE (SIZE (1. .maxCellBlack)) OF PhysCellIdRange
-- ASN1STOP

The part mbsfn-AreaIdList records the MBSFN region identification information corresponding to neighboring cells having the same frequency.

Furthermore, for neighboring cells having different frequencies, if the neighboring cells belong to at least one MBSFN region, the source cell of the UE may inform the UE of MBSFN region identification information of the neighboring cells through the SIB-5. An SIB-5 information unit including MBSFN region identification information is provided below:

-- ASN1START

| | |
|---|---|
| SystemInformationBlockType5 : := | SEQUENCE { |
| interFreqCarrierFreqList | InterFreqCarrierFreqList, |

. . .
}
. . .
-- (skip unchange part)
. . .

| | |
|---|---|
| InterFreqNeighCellList : := | SEQUENCE (SIZE (1. .maxCellInter)) OF InterFreqNeighCellInfo |
| InterFreqNeighCellInfo : := | SEQUENCE { |
| PhysCellId | PhysCellId, |
| q-OffsetCell | Q-OffsetRange, |
| mbsfn-AreaIdList | SEQUENCE (SIZE(1. .maxMBSFN-Area)) OF |
| | INTEGER (0. .255) OPTIONAL, |

}

| | |
|---|---|
| InterFreqBlackCellList : := | SEQUENCE (SIZE (1. .maxCellBlack)) OF PhysCellIdRange |

-- ASN1STOP

The part mbsfn-AreaIdList records the MBSFN region identification information corresponding to neighboring cells having different frequencies.

The MBSFN region identification information may include an MBSFN region name, and information of a frequency used by the MBSFN.

Definitely, it should be understood by persons skilled in the art that the MBSFN region identification information may further include other information, for example MBMS service information provided by the MBSFN region identification information.

Furthermore, MBSFN region identification information of a neighboring cell of a reselection source cell may be provided to a base station of the reselection source cell through operations, administration and maintenance (OAM).

Alternatively, MBSFN region identification information may be exchanged between the base station of the reselection source cell and a multi-cell/multicast coordination entity (MCE) through an application protocol process of an M2 interface.

The method shown in FIG. 2 and the apparatus shown in FIG. 3 are preferably applied in scenarios in which the cell reselection priority level of the second candidate reselection target cell set is higher or lower than the cell reselection priority level of the reselection source cell.

In an embodiment of the present invention, if the second candidate reselection target cell set has at least one cell belonging to at least one MBSFN region, in Step S230 and in the device 330, a cell of an optimal measurement result is selected from the at least one cell belonging to the at least one MBSFN region, so as to serve as the reselection target cell; otherwise

A cell of an optimal measurement result is selected from the second candidate reselection target cell set, so as to serve as the reselection target cell.

As stated above, when the cell reselection priority level of the second candidate reselection target cell set is different from the cell reselection priority level of the reselection source cell, the frequency of any cell in the second candidate reselection target cell set is definitely different from the frequency of the reselection source cell, so the MBSFN region to which the cell in the second candidate reselection target cell set belongs is definitely different from the MBSFN region to which the reselection source cell belongs, and the reason is that the frequencies of the cells belonging to the same MBSFN region have to be the same. Definitely, frequencies of cells belonging to different MBSFN regions may be the same.

Although the MBSFN region to which the cell in the second candidate reselection target cell set belongs is different from the MBSFN region to which the reselection source cell belongs, the MBSFN region to which the cell in the second candidate reselection target cell set belongs may currently or in the future transmit an MBMS service being the same as an MBMS service transmitted by the MBSFN region to which the reselection source cell belongs. Therefore, if the second candidate reselection target cell set has at least one cell belonging to at least one MBSFN region, a cell of an optimal measurement result is selected from the at least one cell belonging to the at least one MBSFN region so as to serve as the reselection target cell, thereby improving continuity of receiving of the MBMS service.

In another embodiment of the present invention, if the second candidate reselection target cell set has at least one cell belonging to at least one MBSFN region transmitting an MBMS service being the same as the MBMS service transmitted by the MBSFN region to which the reselection source cell belongs, in Step S230 and the device 330, a cell of an optimal measurement result is selected from the at least one cell, so as to serve as the reselection target cell; otherwise

If the second candidate reselection target cell set has at least one cell belonging to at least one MBSFN region transmitting an MBMS service being different from the MBMS service transmitted by the MBSFN region to which the reselection source cell belongs, in Step S230 and the device 330, a cell of an optimal measurement result is selected from the at least one cell, so as to serve as the reselection target cell; otherwise, in Step S230 and the device 330, a cell of an optimal measurement result in the second candidate reselection target cell set is selected to serve as the reselection target cell.

According to the embodiment, the cell of the optimal measurement result is preferably reselected from the at least one cell belonging to the at least one MBSFN region transmitting the MBMS service being the same as the MBMS service transmitted by the MBSFN region to which the reselection source cell belongs, so that the continuity of receiving of the MBMS service may be better ensured. However, in the embodiment, the UE needs to know information of the MBMS service provided by the corresponding MBSFN.

Definitely, it should be understood by persons skilled in the art that other embodiments may exist, in which the received MBSFN region identification information of each cell in the second candidate reselection target cell set is considered, and a cell is selected from the second candidate reselection target cell set, so as to serve as the reselection target cell.

Definitely, it should be understood by persons skilled in that art that the method shown in FIG. 2 and the apparatus shown in FIG. 3 are also applicable in scenarios in which the cell reselection priority level of the second candidate reselection target cell set is the same as the cell reselection priority level of the reselection source cell.

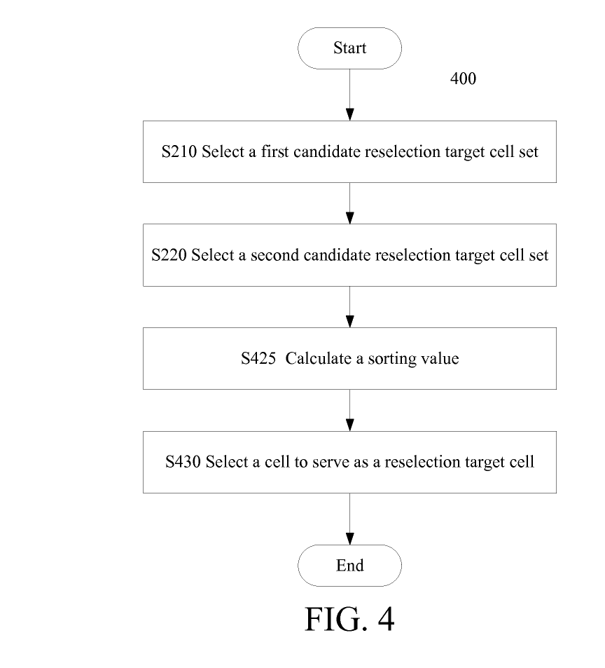

FIG. 4 is a schematic flow chart of a method for performing cell reselection according to another embodiment of the present invention.

As shown in FIG. 4, a method 400 includes the following steps. In Step S210, a first candidate reselection target cell set in which a cell reselection measurement result of each cell meets a first criterion is selected. In Step S220, a second candidate reselection target cell set is selected from the first candidate reselection target cell set according to a cell reselection priority level of each cell in the first candidate reselection target cell set. In Step S425, a sorting value of each cell in the second candidate reselection target cell set is calculated. In Step S430, when the second candidate reselection target cell set has at least two cells each having the sorting value being greater than a threshold value, received MBSFN region identification information of the at least two cells is considered, and a cell is selected from the at least two cells to serve as a reselection target cell.

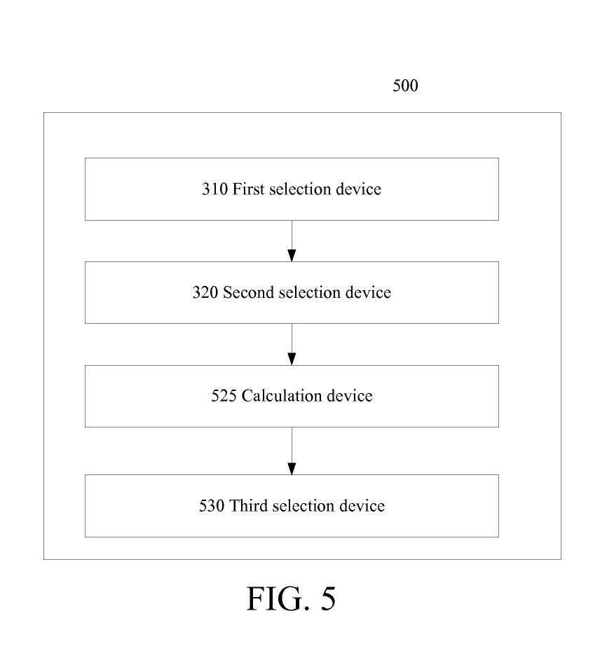

Correspondingly, FIG. 5 is a schematic block diagram of an apparatus for performing cell reselection according to an embodiment of the present invention.

As shown in FIG. 5, an apparatus 500 includes a first selection device 310, configured to select the first candidate reselection target cell set in which the cell reselection measurement result of each cell meets the first criterion; a second selection device 320, configured to select the second candidate reselection target cell set from the first candidate reselection target cell set according to the cell reselection priority level of each cell in the first candidate reselection target cell set; a calculation device 525, configured to calculate the sorting value of each cell in the second candidate reselection target cell set; and a third selection device 530, configured to consider the received MBSFN region identification information of at least two cells when the second candidate reselection target cell set has the at least two cells each having the sorting value being greater than the threshold value, and select a cell from the at least two cells to serve as the reselection target cell.

Compared with the method and apparatus shown in FIG. 2/FIG. 3, the method and apparatus shown in FIG. 4/FIG. 5 include: calculating the sorting value of each cell in the second candidate reselection target cell set, considering the received MBSFN region identification information of the at least two cells when the second candidate reselection target cell set has the at least two cells each having the sorting value being greater than the threshold value, and selecting a cell from the at least two cells to serve as the reselection target cell.

The method shown in FIG. 4 and the apparatus shown in FIG. 5 are applicable in scenarios in which the cell reselection priority level of the second candidate reselection target cell set is the same as the cell reselection priority level of the reselection source cell.

As stated in the standard 3GPP TS36.304 V9.1.0, for the scenarios in which the cell reselection priority level of the second candidate reselection target cell set is the same as the cell reselection priority level of the reselection source cell, an R criterion is defined. For each cell in the second candidate reselection target cell set, a UE needs to calculate the sorting value, that is, an R value, thereof, and select a reselection target cell according to the calculated sorting value. For details of the R criterion, the standard 3GPP TS36.304 V9.1.0 may serve as a reference.

In order to take into account an actual wireless transmission condition, in the embodiment, only when the second candidate reselection target cell set has at least two cells each having the sorting value being greater than a threshold value, for example, the R value of the UE, indicating the actual wireless transmission condition, the received MBSFN region identification information of the at least two cells is considered, and a cell is selected from the at least two cells to serve as the reselection target cell.

When the second candidate reselection target cell set has only one cell having the sorting value being greater than the threshold value, the cell is directly selected to serve as the reselection target cell.

Or, when the second candidate reselection target cell set does not have any cell having the sorting value being greater than the threshold value, the cell having the largest sorting value in the second candidate reselection target cell set is selected to serve as the reselection target cell.

In an embodiment of the present invention, if at least one cell in the at least two cells, which are in the second candidate reselection target cell set and each of which has the sorting value being greater than a threshold value, belongs to an MBSFN region being the same as the MBSFN region to which the reselection source cell belongs, in Step S430 and the device 530, the cell having the largest sorting value in the at least one cell is selected to serve as the reselection target cell; otherwise, in Step S430 and the device 530, the cell having the largest sorting value in the at least two cells is selected to serve as the reselection target cell.

In another embodiment of the present invention, if at least one cell in the at least two cells, which are in the second candidate reselection target cell set and each of which has the sorting value being greater than a threshold value, belongs to an MBSFN region being the same as the MBSFN region to which the reselection source cell belongs, in Step S430 and the device 530, the cell having the largest sorting value in the at least one cell is selected to serve as the reselection target cell; otherwise

If at least one cell in the at least two cells, which are in the second candidate reselection target cell set and each of which has the sorting value being greater than a threshold value, belongs to an MBSFN region being different from the MBSFN region to which the reselection source cell belongs but uses the same frequency as the MBSFN region to which the reselection source cell belongs, in Step S430 and the device 530, the cell having the largest sorting value in the at least one cell is selected to serve as the reselection target cell; otherwise

In Step S430 and the device 530, the cell having the largest sorting value in the at least two cells is selected to serve as the reselection target cell.

According to another embodiment of the present invention, if at least one cell in the at least two cells, which are in the second candidate reselection target cell set and each of which has the sorting value being greater than a threshold value, belongs to an MBSFN region being the same as the MBSFN region to which the reselection source cell belongs, in Step S430 and the device 530, the cell having the largest sorting value in the at least one cell is selected to serve as the reselection target cell; otherwise

If at least one cell in the at least two cells, which are in the second candidate reselection target cell set and each of which has the sorting value being greater than a threshold value, belongs to an MBSFN region being different from the MBSFN region to which the reselection source cell belongs but uses the same frequency as the MBSFN region to which the reselection source cell belongs, in Step S430 and the device 530, the cell having the largest sorting value in the at least one cell is selected to serve as the reselection target cell; otherwise

If at least one cell in the at least two cells, which are in the second candidate reselection target cell set and each of which has the sorting value being greater than a threshold value, belongs to an MBSFN region being different from the MBSFN region to which the reselection source cell belongs and uses a frequency different from a frequency used by the MBSFN region to which the reselection source cell belongs, in Step S430 and the device 530, the cell having the largest sorting value in the at least one cell is selected to serve as the reselection target cell; otherwise

In Step S430 and the device 530, the cell having the largest sorting value in the at least two cells is selected to serve as the reselection target cell.

Definitely, it should be understood by persons skilled in the art that another embodiment may exist, in which when the second candidate reselection target cell set has at least two cells each having the sorting value being greater than a threshold value, the received MBSFN region identification information of the at least two cells is considered, and a cell is selected from the at least two cells to serve as the reselection target cell.

For example, in another embodiment, if at least one cell in the at least two cells, which are in the second candidate reselection target cell set and each of which has the sorting value being greater than a threshold value, belongs to an MBSFN region being the same as the MBSFN region to which the reselection source cell belongs, in Step S430 and the device 530, the cell having the largest sorting value in the at least one cell is selected to serve as the reselection target cell; otherwise

If at least one cell in the at least two cells, which are in the second candidate reselection target cell set and each of which has the sorting value being greater than a threshold value, partially belongs to the MBSFN region to which the reselection source cell belongs, in Step S430 and the device 530, the cell having the largest sorting value or the highest belongingness degree in the at least one cell is selected to serve as the reselection target cell; otherwise

If at least one cell in the at least two cells, which are in the second candidate reselection target cell set and each of which has the sorting value being greater than a threshold value, belongs to an MBSFN region being different from the MBSFN region to which the reselection source cell belongs but uses the same frequency as the MBSFN region to which the reselection source cell belongs, in Step S430 and the device 530, the cell having the largest sorting value in the at least one cell is selected to serve as the reselection target cell; otherwise

If at least one cell in the at least two cells, which are in the second candidate reselection target cell set and each of which has the sorting value being greater than a threshold value, belongs to an MBSFN region being different from the MBSFN region to which the reselection source cell belongs and uses a frequency different from a frequency used by the MBSFN region to which the reselection source cell belongs, in Step S430 and the device 530, the cell having the largest sorting value in the at least one cell is selected to serve as the reselection target cell; otherwise

In Step S430 and the device 530, the cell having the largest sorting value in the at least two cells is selected to serve as the reselection target cell.

For example, if the reselection source cell belongs to three MBSFN regions, a first candidate reselection target cell belongs to two MBSFN regions among the three MBSFN regions, and a second candidate reselection target cell belongs to one MBSFN region among the three MBSFN regions, the belongingness degree of the first candidate reselection target cell is higher than the belongingness degree of the second candidate reselection target cell.

For example, in another embodiment of the present invention, if at least one cell in the at least two cells, which are in the second candidate reselection target cell set and each of which has the sorting value being greater than a threshold value, belongs to an MBSFN region being the same as the MBSFN region to which the reselection source cell belongs, in Step S430 and the device 530, the cell having the largest sorting value in the at least one cell is selected to serve as the reselection target cell; otherwise

If at least one cell in the at least two cells, which are in the second candidate reselection target cell set and each of which has the sorting value being greater than a threshold value, belongs to at least one MBSFN region transmitting an MBMS service the same as an MBMS service transmitted by the MBSFN region to which the reselection source cell belongs, in Step S430 and the device 530, the cell having the largest sorting value in the at least one cell is selected to serve as the reselection target cell; otherwise

If at least one cell in the at least two cells, which are in the second candidate reselection target cell set and each of which has the sorting value being greater than a threshold value, belongs to an MBSFN region being different from the MBSFN region to which the reselection source cell belongs but uses the same frequency as the MBSFN region to which the reselection source cell belongs, in Step S430 and the device 530, the cell having the largest sorting value in the at least one cell is selected to serve as the reselection target cell; otherwise

If at least one cell in the at least two cells, which are in the second candidate reselection target cell set and each of which has the sorting value being greater than a threshold value, belongs to an MBSFN region being different from the MBSFN region to which the reselection source cell belongs and uses a frequency different from a frequency used by the MBSFN region to which the reselection source cell belongs, in Step S430 and the device 530, the cell having the largest sorting value in the at least one cell is selected to serve as the reselection target cell; otherwise

In Step S430 and the device 530, the cell having the largest sorting value in the at least two cells is selected to serve as the reselection target cell.

However, in the embodiment, the UE needs to know information of the MBMS service provided by the corresponding MBSFN.

Results of using the present invention is described below with reference to FIG. 1.

It is assumed that a cell 5 and a cell 6 are members of second candidate reselection target cells of the reselection source cell according to their respective cell reselection measurement results and cell reselection priority levels, and sorting values of the cell 5 and the cell 6 are calculated, that is, for R values, respectively R₅=2 and R₆=2.5. Furthermore, it is assumed that the threshold value T_{mbms}=1.5.

Obviously, the sorting values of the cell 5 and the cell 6 are both greater than the threshold value. The reselection source cell belongs to the MBSFN region 1 and the MBSFN region 2, and the cell 5 also belongs to the MBSFN region 1 and the MBSFN region 2, but the cell 6 only belongs to the MBSFN region 2; therefore, although the R value of the cell 6 is greater than the R value of the cell 5, the cell 5 has the R value also being greater than the threshold value and has the communication quality meeting corresponding conditions; therefore according to the present invention, the cell 5 is selected to serve as the reselection target cell, so as to improve the continuity of receiving of the MBMS service.

The present invention further relates to a method for assisting in performing cell reselection, which includes:

sending MBSFN region identification information of a neighboring cell.

Furthermore, the present invention further relates to an apparatus for assisting in performing cell reselection, which includes: a sending device, configured to send MBSFN region identification information of a neighboring cell.

The method for assisting in performing cell reselection may be executed by an evolved Node B (eNB), and therefore the apparatus for assisting in performing cell reselection may be an eNB.

It should be noted that, in order to make the present invention easier to understand, the above description saves some technical details which are commonly known by persons skilled in the art, possibly required by implementation of the present invention, and more specific.

Therefore, selection and description of the embodiments are for explaining the principles of the present invention and actual applications thereof better, and it should be understood by persons of ordinary skill in the art that all modifications and variations made without departing from the essence of the present invention fall within the protection scope of the present invention defined by the claims.

Furthermore, it should be understood by persons skilled in the art that the described steps of the methods may be implemented by a programming computer. Herein some embodiments are intended to cover the program storage device, which is readable to a machine or a computer and has a coded instruction program capable of being executed by the machine or the computer. The instruction executes some or all of the steps of the methods. The program storage device may be, for example, a magnetic storage medium such as a magnetic disk and a magnetic tape, a hard disk driver, and an optical readable digital data storage medium. The embodiments are also intended to cover a computer programmed to execute the steps of the methods.

1. A method for performing cell reselection, comprising:
selecting a first candidate reselection target cell set in which a cell reselection measurement result of each cell meets a first criterion;
selecting a second candidate reselection target cell set from the first candidate reselection target cell set according to a cell reselection priority level of each cell in the first candidate reselection target cell set; and
considering received Multicast Broadcast Single Frequency Network (MBSFN) region identification information of each cell in the second candidate reselection target cell set, and selecting a cell from the second candidate reselection target cell set to serve as a reselection target cell.

2. The method according to claim 1, wherein
if the second candidate reselection target cell set has at least one cell belonging to at least one MBSFN region, a cell of an optimal measurement result is selected from the at least one cell belonging to the at least one MBSFN region, so as to serve as the reselection target cell; otherwise
a cell of an optimal measurement result is selected from the second candidate reselection target cell set, so as to serve as the reselection target cell.

3. The method according to claim 1, wherein
if the second candidate reselection target cell set has at least one cell belonging to at least one MBSFN region transmitting a Multimedia Broadcast Multicast Service (MBMS) service being the same as an MBMS service transmitted by an MBSFN region to which a reselection source cell belongs, a cell of an optimal measurement result is selected from the at least one cell, so as to serve as the reselection target cell; otherwise
if the second candidate reselection target cell set has at least one cell belonging to at least one MBSFN region transmitting an MBMS service being different from the MBMS service transmitted by the MBSFN region to which the reselection source cell belongs, a cell of an optimal measurement result is selected from the at least one cell, so as to serve as the reselection target cell; otherwise
a cell of an optimal measurement result is selected from the second candidate reselection target cell set, so as to serve as the reselection target cell.

4. A method for performing cell reselection, comprising:
selecting a first candidate reselection target cell set in which a cell reselection measurement result of each cell meets a first criterion;
selecting a second candidate reselection target cell set from the first candidate reselection target cell set according to a cell reselection priority level of each cell in the first candidate reselection target cell set;
calculating a sorting value of each cell in the second candidate reselection target cell set; and
when the second candidate reselection target cell set has at least two cells each having the sorting value being greater than a threshold value, considering received Multicast Broadcast Single Frequency Network (MBSFN) region identification information of the at least two cells, and selecting a cell from the at least two cells to serve as a reselection target cell.

5. The method according to claim 4, wherein
if at least one cell in the at least two cells belongs to an MBSFN region being the same as an MBSFN region to which a reselection source cell belongs, a cell having the largest sorting value in the at least one cell is selected to serve as the reselection target cell; otherwise
a cell having the largest sorting value in the at least two cells is selected to serve as the reselection target cell.

6. The method according to claim 4, wherein
if at least one cell in the at least two cells belongs to an MBSFN region being the same as an MBSFN region to which a reselection source cell belongs, a cell having the largest sorting value in the at least one cell is selected to serve as the reselection target cell; otherwise
if at least one cell in the at least two cells belongs to an MBSFN region being different from the MBSFN region to which the reselection source cell belongs but uses the same frequency as the MBSFN region to which the reselection source cell belongs, a cell having the largest sorting value in the at least one cell is selected to serve as the reselection target cell; otherwise
a cell having the largest sorting value in the at least two cells is selected to serve as the reselection target cell.

7. (canceled)

8. (canceled)

9. (canceled)

10. An apparatus for performing cell reselection, comprising:
a first selection device, configured to select a first candidate reselection target cell set in which a cell reselection measurement result of each cell meets a first criterion;
a second selection device, configured to select a second candidate reselection target cell set from the first candidate reselection target cell set according to a cell reselection priority level of each cell in the first candidate reselection target cell set; and
a third selection device, configured to consider received Multicast Broadcast Single Frequency Network (MBSFN) region identification information of each cell in the second candidate reselection target cell set, and select a cell from the second candidate reselection target cell set to serve as a reselection target cell.

11. The apparatus according to claim 10, wherein
if the second candidate reselection target cell set has at least one cell belonging to at least one MBSFN region, the third selection device selects a cell of an optimal measurement result from the at least one cell belonging to the at least one MBSFN region, so as to serve as the reselection target cell; otherwise
the third selection device selects a cell of an optimal measurement result from the second candidate reselection target cell set, so as to serve as the reselection target cell.

12. The apparatus according to claim 10, wherein
if the second candidate reselection target cell set has at least one cell belonging to at least one MBSFN region transmitting a Multimedia Broadcast Multicast Service (MBMS) service being the same as an MBMS service transmitted by an MBSFN region to which a reselection source cell belongs, the third selection device selects a cell of an optimal measurement result from the at least one cell, so as to serve as the reselection target cell; otherwise
if the second candidate reselection target cell set has at least one cell belonging to at least one MBSFN region transmitting an MBMS service being different from the MBMS service transmitted by the MBSFN region to which the reselection source cell belongs, the third selection device selects a cell of an optimal measurement result from the at least one cell, so as to serve as the reselection target cell; otherwise
the third selection device selects a cell of an optimal measurement result from the second candidate reselection target cell set, so as to serve as the reselection target cell.

13. An apparatus for performing cell reselection, comprising:
a first selection device, configured to select a first candidate reselection target cell set in which a cell reselection measurement result of each cell meets a first criterion;
a second selection device, configured to select a second candidate reselection target cell set from the first candidate reselection target cell set according to a cell reselection priority level of each cell in the first candidate reselection target cell set;
a calculation device, configured to calculate a sorting value of each cell in the second candidate reselection target cell set; and
a third selection device, configured to consider received Multicast Broadcast Single Frequency Network (MBSFN) region identification information of at least two cells when the second candidate reselection target cell set has the at least two cells each having the sorting value being greater than a threshold value, and select a cell from the at least two cells to serve as a reselection target cell.

14. The apparatus according to claim 13, wherein
if at least one cell in the at least two cells belongs to an MBSFN region being the same as an MBSFN region to which a reselection source cell belongs, the third selection device selects a cell having the largest sorting value in the at least one cell to serve as the reselection target cell; otherwise
the third selection device selects a cell having the largest sorting value in the at least two cells to serve as the reselection target cell.

15. The apparatus according to claim 13, wherein
if at least one cell in the at least two cells belongs to an MBSFN region being the same as an MBSFN region to which a reselection source cell belongs, the third selection device selects a cell having the largest sorting value in the at least one cell to serve as the reselection target cell; otherwise
if at least one cell in the at least two cells belongs to an MBSFN region being different from the MBSFN region to which the reselection source cell belongs but uses the same frequency as the MBSFN region to which the reselection source cell belongs, the third selection device selects a cell having the largest sorting value in the at least one cell to serve as the reselection target cell; otherwise
the third selection device selects a cell having the largest sorting value in the at least two cells to serve as the reselection target cell.

16. The apparatus according to claim 13, wherein
if at least one cell in the at least two cells belongs to an MBSFN region being the same as an MBSFN region to which a reselection source cell belongs, the third selection device selects a cell having the largest sorting value in the at least one cell to serve as the reselection target cell; otherwise
if at least one cell in the at least two cells belongs to an MBSFN region being different from the MBSFN region to which the reselection source cell belongs but uses the same frequency as the MBSFN region to which the reselection source cell belongs, the third selection device selects a cell having the largest sorting value in the at least one cell to serve as the reselection target cell; otherwise
if at least one cell in the at least two cells belongs to an MBSFN region being different from the MBSFN region to which the reselection source cell belongs and uses a frequency different from a frequency used by the MBSFN region to which the reselection source cell belongs, the third selection device selects a cell having the largest sorting value in the at least one cell to serve as the reselection target cell; otherwise
the third selection device selects a cell having the largest sorting value in the at least two cells to serve as the reselection target cell.

17. A method for assisting in performing cell reselection, comprising:
sending Multicast Broadcast Single Frequency Network (MBSFN) region identification information of a neighboring cell.

18. An apparatus for assisting in performing cell reselection, comprising:
a sending device, configured to send Multicast Broadcast Single Frequency Network (MBSFN) region identification information of a neighboring cell.
